(19) United States
(12) Patent Application Publication
(10) Pub. No.: US 2026/0154110 A1
(43) Pub. Date: Jun. 4, 2026

(54) Efficient Memory Reuse Method for Storing Feature Maps on Edge Devices

(71) Applicants: Yan Wang, Kowloon (HK); Tao Li, Kowloon (HK); Wing Ki Yeung, Lai Chi Kok (HK)

(72) Inventors: Yan Wang, Kowloon (HK); Tao Li, Kowloon (HK); Wing Ki Yeung, Lai Chi Kok (HK)

(21) Appl. No.: 18/967,728

(22) Filed: Dec. 4, 2024

(51) Int. Cl. G06F 9/50

(52) U.S. Cl. CPC G06F 9/5016; G06F 9/5038; G06F 9/5061

(57) ABSTRACT

Systems and methods optimize memory utilization in the execution of neural networks (DNNs) on devices such as resource-constrained edge devices. The method includes dividing neural network nodes into normal nodes and concat nodes; sorting normal nodes in descending order of feature map size; allocating memory addresses for normal nodes using a best-fit search; and allocating memory addresses for concat nodes using a relaxed-fit search.

### BACKGROUND OF THE INVENTION

### Field of Invention

The invention relates to efficient memory space utilization for storing intermediate feature maps for deep neural network models.

### Background of the Invention

Edge devices and neural processing units (NPUs) are currently receiving significant attention and are highly discussed topics. A typical edge device, for example, a TESLA car, needs to run 50 different image processing AI models simultaneously. Besides, a typical AI model in image processing domain requires about 100 MB to 200 MB (@INT16 ) memory space for storing parameters and feature maps. Further, a typical inference NPU on edge devices usually has on-chip memory (SRAM) with size of 512 KB to 32 MB. Edge devices usually have stringent budget on memory (DRAM) and the memory can be reused to reduce memory consumption for feature maps. Moreover, some feature maps can also be stored to SRAM to reduce power consumption. This proposed invention relates to a memory reuse algorithm to efficiently allocate memory address of an AI model in both SRAM and DRAM, thereby saving memory space and power consumption for NPU.

### SUMMARY OF THE INVENTION

In one aspect, the method involves organizing deep neural network nodes into two categories: normal and concat nodes. Normal nodes are then arranged based on the size of their feature maps in descending order. Memory allocation for these normal nodes is accomplished using a best-fit search strategy. For concat nodes, memory addresses are assigned using a more flexible relaxed-fit search technique.

In another aspect, the present method enhances memory efficiency in neural network processing on edge devices by categorizing nodes according to their memory needs, using distinct memory allocation algorithms for each category. The method strategically employs SRAM and DRAM for memory allocation and refines memory addresses for optimal efficiency and reliability. Furthermore, the method gives precedence to SRAM allocation for nodes that have brief life-cycles and require less memory for feature maps.

In a further aspect, the edge device includes components designed to manage neural network nodes. The device features a mechanism for classifying the nodes into two categories: normal nodes and concat nodes. Once categorized, the device sorts the normal nodes by the size of their feature maps in descending order. For memory allocation, the device utilizes a best-fit search approach for normal nodes, ensuring efficient use of memory. Conversely, for concat nodes, the device employs a relaxed-fit search method to allocate memory addresses, which provides flexibility in memory management.

Advantages of one implementation may include one or more of the following:
One implementation increases the computational efficiency of neural networks on edge devices by reducing memory-related bottlenecks. This ensures that devices with limited computational capabilities can still perform complex calculations required in AI applications.

By introducing the best-fit and relaxed-fit allocation methods for different node types, one implementation maximizes the efficient use of available memory, thus allowing for a larger and potentially more sophisticated neural network to be run on resource-constrained devices.

The memory allocation strategy helps to minimize latency often associated with memory access times. This is because the approach seeks to ensure that memory is used as effectively as possible, reducing delay due to memory paging or excessive data exchange with external memory sources.

The sorting of feature maps in descending order for normal nodes can lead to enhanced memory locality, which can improve cache performance and further reduce access times, providing a faster and more responsive AI system on edge devices.

By utilizing both SRAM and DRAM in the allocation process pragmatically, one implementation takes advantage of the quicker access times of SRAM for more critical or frequently accessed nodes while still providing the larger storage capacity of DRAM for less critical data.

The tailored approach of prioritizing SRAM allocation to nodes with shorter life-cycles aligns with real-time processing requirements of edge computing applications, where timely data processing is critical.

The dynamic memory allocation technique may lead to increased reliability and a longer operational lifespan of edge devices by avoiding memory fragmentation and efficiently managing the write operations to various types of memory (volatile and non-volatile), thus reducing wear and tear.

The advanced memory management strategy advocated by this one implementation may provide competitive advantages for devices operating in IoT, autonomous systems, and real-time analytics, where processing efficiency and swift decision-making are vital.

The one implementation facilitates the scalability of neural network implementation, as the effective memory management can accommodate growth in the complexity of models as new layers or nodes are added.

Finally, this innovative method allows the conservation of energy by mitigating the need for external data storage solutions, which would typically require additional power and may introduce communication overhead that consumes even more energy.

The technique incorporates selective memory allocation strategies, including best-fit and relaxed-fit methods, aimed at enhancing the efficiency of memory address assignments. Furthermore, the system adeptly handles memory distribution across both static (SRAM) and dynamic (DRAM) random access memories, imposing constraints on the size and lifespan of nodes to preferentially allocate SRAM for those with certain characteristics. This not only conserves memory space but also ensures the seamless operation of the nodes in sequence, which is critical given the limited computational and memory capacities of edge devices. By implementing such a system, complex DNN operations can be performed on edge devices more efficiently, making it possible to support advanced functions that were traditionally beyond their capability due to power and spatial limitations. Overall, one implementation promises substantial enhancements in the performance of neural networks in edge devices, paving the way for advanced AI capabilities in a world increasingly reliant on smart and autonomous systems.

### BRIEF DESCRIPTION OF DRAWINGS

FIG. 1 shows an exemplary flowchart depicting a process for allocating memory addresses for neural network nodes.

FIG. 2 shows an exemplary flowchart illustrating efficient memory management for feature maps in edge-deployed neural networks.

FIG. 3 shows a best-fit search flowchart for efficient memory management in edge-deployed neural networks.

FIGS. 4-5 show exemplary pseudo-code for static memory planning and best-fit search, respectively.

FIGS. 6A-6B show pseudocode and flow-chart for an exemplary relaxed-fit search process.

FIG. 7 is a table illustrating exemplary operations of the process of FIG. 1 and further illustrating the storage saving achieved with the process of FIG. 1.

### DETAILED DESCRIPTION OF THE INVENTION

A method for efficient memory space utilization stores intermediate feature maps for deep neural network models with a memory planning algorithm. The memory planning algorithm, which divides nodes into two categories: one is normal nodes, which will be sorted in a descending order of its feature map size, and the other is nodes that needs to be concatenated, where a set of nodes that are concatenated together is dubbed as a concat tuple. The memory planning algorithm utilizes: a best-fit search algorithm to allocate memory address for normal nodes, and a relaxed-fit search algorithm to allocate memory address for concat nodes.

The memory planning algorithm allocates memory for intermediate feature maps of each node, in both static random access memory (SRAM) and dynamic random access memory (DRAM), and it allocates memory in SRAM first and then it allocates memory in DRAM, and with provided size limit, namely, SRAM size limit and DRAM size limit, and with provided life-cycle limit of nodes to be allocated in SRAM and life-cycle limit of nodes to be allocated in DRAM, whereby SRAM can bypass nodes with excessively long life-cycle.

In one example, the best-fit search algorithm tries to:
i. get a list of nodes that have already been allocated an address and are overlapped in life-cycle with the current node, from an allocated node list; and
ii. find a list of memory spaces partitioned by the list of allocated and overlapped nodes; and
iii. find the smallest space that is big enough to hold the current node; and
iv. allocate the starting address of the space to be the address of the current node; and
v. insert the current node into the allocated node list and sort the allocated node list in ascending order of address.

The relaxed-fit search algorithm:
i. Divides concat tuples into 2 sub-types,
   I. concat tuple list of unique node (sub-type 1): the concat tuples that have no shared/common node with other concat tuples, and
   II. concat tuple list of common node (sub-type 2): the concat tuples that have shared/common node(s) with other concat tuples.
   III. concat tuple list of unique node can be allocated in either SRAM or DRAM
   IV. concat tuple list of common node can only be allocated in DRAM.
ii. For each tuple in the concat tuple list of unique node:
   I. all nodes in the same tuple will be grouped to be a supernode, wherein
      1) its start node is the minimum start node of all nodes in the tuple,
      2) its end node is the maximum end node of all nodes in the tuple, and
      3) its size is the total feature map size of all nodes in the tuple.
   II. The supernode will go through the best-fit search algorithm to get an address in the memory,
      1) the address of the first node in the tuple is the address of the supernode;
      2) the address of the next node ([n+1]) is the end address of the current node ([n]): the address of the current node plus the output feature map size of the current node;
      3) insert all nodes in the same tuple into the allocated node list and sort same in ascending order of address;
iii. For each tuple in the concat tuple list of common node,
   I. all nodes in the same tuple will first be assigned the address immediately after the largest end address of all overlapping nodes that have previously been allocated an address.
   II. the “all overlapping nodes that have previously been allocated an address” do not include the previously allocated common node.
   III. insert all nodes into the allocated node list and sort same in ascending order of address.
   IV. the address of each node will be adjusted so that they preserve the same order in the concat operator: if the address of the next node is less than the end address of the current node, then the address of the next node is assigned to be the end address of the current node.
   V. the address of each node will be concatenated together by moving nodes to the right (large) side in a reversed order: if the end address of the previous node ([n−1]) is less than the address of the current node ([n]), the address of the previous node is assigned to be the address of the current node minus the output feature map size of the previous node.

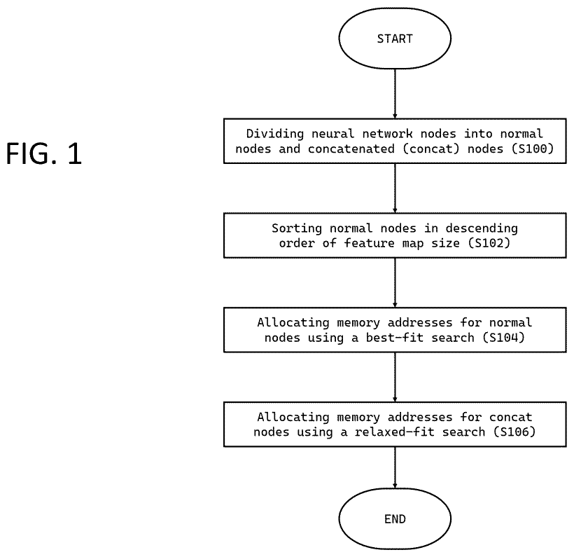

FIG. 1 illustrates an exemplary flowchart depicting a process for allocating memory addresses for neural network nodes. The method manages memory allocation for neural network nodes by categorizing them into two types: normal nodes and concat nodes. This categorization process, denoted as S100, involves analyzing the deep neural network nodes and distinguishing them based on their function and structure. By segregating the nodes into normal and concat categories, the method facilitates more efficient and tailored memory management strategies. Following this, the normal nodes are arranged based on the size of their feature maps, ordered from the largest to the smallest, in descending order (S102). This method ensures that nodes with the largest feature maps are considered first during subsequent memory allocation processes.

Once the neural network nodes are divided, the normal nodes are sorted in descending order of their feature map size (S102). Subsequently, memory addresses for these normal nodes are allocated using a best-fit search technique (S104). This best-fit search approach ensures efficient usage of available memory space by finding the smallest memory block that can accommodate each normal node's requirements. Finally, a relaxed-fit search method is employed to allocate memory addresses for the concat nodes (S106).

The memory planning algorithm efficiently allocates memory for intermediate feature maps of each node by prioritizing allocation in SRAM first and then in DRAM. It adheres to predetermined size limits and life-cycle limits for both SRAM and DRAM, enabling SRAM to bypass nodes with excessively long life-cycles.

The best-fit search algorithm attempts to identify existing nodes that have already been assigned an address and have overlapping life-cycles with the current node. It then locates memory spaces created by these nodes and selects the smallest space that can accommodate the current node. The algorithm assigns the starting address of this space to the current node, adds the node to the allocated node list, and sorts the list in ascending order of addresses.

The relaxed-fit search algorithm categorizes concat tuples into two lists: concat tuple list of unique nodes (sub-type 1), which have no shared/common nodes with other tuples and can be allocated in either SRAM or DRAM, and concat tuple list with common nodes (sub-type 2). For each tuple in the concat tuple list of unique nodes, all nodes within the same tuple are combined into a single supernode. The start node of this supernode is the minimum start node of all individual nodes in the tuple, the end node is the maximum end node among them, and its size is the cumulative feature map size of all nodes in the tuple. This supernode is then processed using the best-fit search algorithm to determine its address in memory. The address of the first node in the tuple is set to the address of the supernode. For the subsequent node ([n+1]), its address is determined by the end address of the current node ([n]), which is the address of the current node plus its output feature map size. All nodes within the same tuple are then inserted into the allocated node list, which is sorted in ascending order of address.

For each tuple in the concat tuple list with common nodes, all nodes in the tuple are initially assigned an address immediately following the largest end address of all previously allocated overlapping nodes. All nodes are then inserted into the allocated node list and sorted in ascending order of address. Subsequently, the address of each node is adjusted to maintain their order in the concat operator: if the address of the next node is less than the end address of the current node, the address of the next node is updated to match the end address of the current node.

The addresses of each node are re-organized by shifting nodes to the right in reverse order. Specifically, if the end address of the previous node (n−1) is smaller than the start address of the current node (n), the end address of the previous node is updated to be the start address of the current node minus the output feature map size of the previous node.

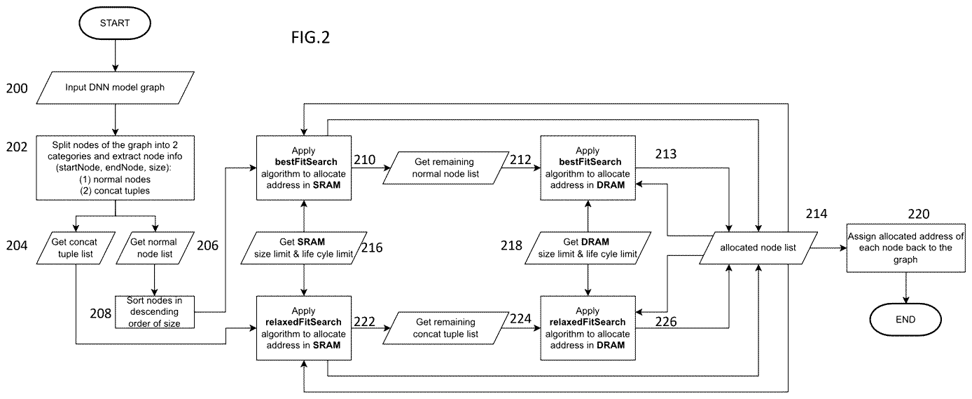

FIG. 2 illustrates another method that enhances memory efficiency during the execution of deep neural learning networks on edge devices with limited resources. This method streamlines neural computation by organizing the nodes of an input deep neural network (DNN) model graph at 200 into distinct categories that facilitate more effective memory management. After receiving the DNN model graph, at 202 the system identifies and classifies nodes into two principal categories: normal nodes list at 206, and concat node tuple list at 204. The normal nodes are sorted at 208 by the size of the feature maps they produce, in a descending order, facilitating a prioritized allocation strategy. Thereafter, a best-fit search algorithm is employed at 210 to allocate suitable memory addresses to these nodes within the static random-access memory (SRAM) and dynamic random-access memory (DRAM) units, the allocation of which is determined by predefined size and life-cycle limits for the nodes. The SRAM size limit is established to identify the maximum amount of SRAM available for memory allocations, thus ensuring that the SRAM is neither over-committed nor underutilized. By understanding the SRAM capacity, the method can efficiently distribute memory addresses amongst normal nodes within the SRAM constraints, optimizing for quick access times and reduced latency.

The concat nodes from 204 are treated with a relaxed-fit search algorithm at 222, which permits greater flexibility in assigning memory addresses due to their inherent characteristic of merging outputs. By attributing memory addresses in such a tailored manner, the method effectively utilizes the limited memory resources of edge devices, improving their ability to run complex DNNs while maintaining system reliability and processing speed.

After the initial separation of the DNN nodes into normal nodes and concat nodes as per their distinct characteristics, the “get normal node list” operation at 206 involves extracting from the input DNN model graph 200 all the nodes categorized as normal nodes. This extraction is part of the pre-processing phase and serves as a primary step before further actions concerning normal nodes are taken, setting the stage for subsequent memory allocation procedures for efficient DNN execution on edge devices.

By arranging the normal nodes according to the size of their feature maps in a descending manner, the method ensures that larger nodes are considered first for memory placement, which typically allows for a more efficient distribution of memory. This arrangement endeavors to minimize wasted space that could occur when attempting to fit larger nodes into gaps left between smaller ones. Following this strategic orientation, efficient utilization of both Static Random-Access Memory (SRAM) and Dynamic Random-Access Memory (DRAM) can be accomplished, further enhancing the overall effectiveness of the DNN's execution within the constrained environment of an edge device.

This categorization and ordering approach enables one implementation to employ different memory allocation strategies suited to the characteristics of each category of nodes, such as the best-fit search strategy for normal nodes and a relaxed-fit strategy for concat nodes, leading to optimized usage and management of the precious and limited memory resources in edge computing applications.

In relation to normal nodes, the method of FIG. 2 employs the best-fist search (bestFitSearch) algorithm, a mechanism that examines available memory spaces and matches these normal nodes to spaces in a manner akin to a best-fit perspective, thereby striving for minimal wastage of memory resources. At 212, the best-fit search algorithm assigns memory addresses to normal nodes within the DRAM, ensuring each node is accorded an address that best corresponds to its size requirements, thereby contributing to a reduction in memory fragmentation and ensuring a more consolidated use of the DRAM. This careful alignment of nodes to memory spaces not only augments memory utilization but also bolsters the performance of the DNN as it operates on the edge device, a vital characteristic given the limited resources commonly associated with such devices. The result is saved at 214 in a repository for nodes that have already been allocated memory resources.

The concat nodes, due to their nature, require a different memory management approach compared to normal nodes. The relaxed-fit search (relaxedFitSearch) algorithm is designed to provide flexibility in the memory allocation process for these concat nodes. This algorithm identifies suitable memory spaces within the SRAM that can accommodate the variable size requirements of concat nodes without imposing the stringent constraints typical of best-fit strategies. The application of this algorithm ensures that memory fragmentation is minimized and that the utilization of available SRAM is optimized, both of which are of particular importance in resource-constrained edge devices.

Concat nodes are processed through a relaxed-fit search algorithm to allocate address in SRAM at 222 that allows for greater flexibility within the constraints of memory management and node requirements. At 224, the remaining concat tuple list is used for remapping the allocated addresses back to the nodes in the input DNN model graph at 200, ensuring a seamless integration of the memory allocation within the neural network structure, while providing improved efficiency and performance on edge devices.

The life-cycle limit of nodes is assessed to determine the duration for which a node retains relevance during the processing of a DNN. This parameter is used for nodes with shorter life-cycles that would benefit from faster SRAM memory, as opposed to those with longer life-cycles which may be more suitably allocated to Dynamic Random-Access Memory (DRAM) at 226. By evaluating the life-cycle of each node and juxtaposing it with the SRAM size limit, the inventive method ensures that memory allocation is both strategic and economical, thereby maximizing the potential of limited memory resources on edge devices for DNN computations.

After the categorization and sorting of nodes within a deep neural network have been completed, the edge device integrates the newly allocated memory addresses into the network's structure for seamless operation. Once the allocation for both normal and concat nodes is completed, each node alongside its assigned address is catalogued into the allocated node list 214. The method proceeds to assign allocated address of each node back to the graph at 220. The allocated address of each node is reassigned back to the network model to update the internal data flow of the neural network. Thus, each node within the input deep neural network model graph 200, whether it is a normal node processed by steps 210-213, or a concat node handled by steps 222-226, is now linked to a specific memory address, where the neural network's operations can be executed accordingly. This process assigns the optimized memory allocation slots to the corresponding nodes within the neural network, enabling the device to manage cognitive tasks efficiently without superfluous memory access delays or computational bottlenecks, thus maximizing the limited computational resources of edge devices.

The method described offers an innovative approach for managing the dynamic allocation of memory for deep neural network (DNN) nodes in edge devices. This method extends memory allocation by differentiating between ‘normal’ and ‘concat’ nodes within the DNN's architecture. Normal nodes, as recognized by the system, are those without concatenation operations, and they are sorted by the feature maps'sizes into a descending order. Concat nodes, on the other hand, which are normal nodes connected to a concat operator that merges feature maps from these nodes, are managed separately due to their differing memory characteristics. Once sorted, normal nodes undergo a meticulous memory allocation process to optimize memory usage. This is achieved by employing a best-fit search algorithm that seeks the most suitable memory spaces in both static random-access memory (SRAM) and dynamic random-access memory (DRAM) based on predefined size and life-cycle limits. SRAM, being faster but typically smaller in capacity, is considered a premium resource and is allocated preferentially to nodes demanding more immediate and rapid access, particularly those with smaller feature maps and shorter lifespan.

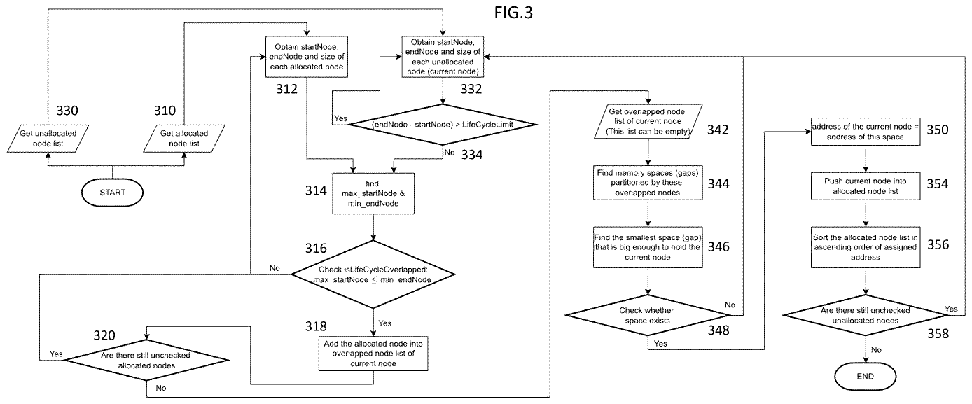

FIG. 3 shows more details in the operation of the best-fit search process. Further refinements in the method are applied, starting with the retrieval of the allocated node list 310. For each allocated node, its start and end node as well as size are obtained at 312, allowing for the calculation of the maximum start node and the minimum end node at 314. The system checks for overlaps in node life cycles at 316 and appends any overlapping nodes to the current node's list of overlapped nodes 318. This check continues iteratively until there are no more nodes to verify at 320.

In parallel, unallocated nodes are handled. The unallocated node list is obtained at 330, and for each unallocated node, details such as start node, end node, and size are acquired at 332. A decision is made based on whether the node's life cycle exceeds the life-cycle limit at 334. Current nodes are examined for overlaps at 342, and memory spaces partitioned by these overlapped nodes are identified at 344.

The smallest fit space that can accommodate the current node is selected at 346. Once a suitable space is found at 348, the current node's address is assigned accordingly at 350, and it is added to the allocated node list at 354. Finally, the allocated node list is sorted in increasing order based on assigned addresses 356, and the cycle continues until all nodes are allocated at 358.

After obtaining the list of allocated nodes at 310, the next step in the method involves obtaining the start node, end node, and size of each allocated node at 312. This action is essential for accurately determining the positional and dimensional attributes of each node within the allocated memory space. The gathered information is subsequently used to identify the maximum starting node and minimum ending node, facilitating further steps in the memory management process.

After determining whether the life cycle of nodes overlaps at 316 (“check isLifeCycleOverlapped: max_startNode≤min_endNode”), the process moves to step 318. Here, if the life cycles do overlap, the allocated node is added to an overlapped node list associated with the current node. This step facilitates the management and tracking of nodes that share overlapping life cycles, ensuring efficient use of memory resources during the execution of the neural network on the edge device.

At 332 the process obtains the start node, end node, and size of each unallocated node, referred to as the current node. This step determines whether the node can be accommodated within the specified life-cycle limit and is essential for efficiently managing memory resources. At 334 the process evaluates the condition “(endNode−startNode) greater than LifeCycleLimit.” This decision point assesses whether the difference between the endNode and startNode of each unallocated node exceeds the predetermined LifeCycleLimit.

From 320, the process determines the overlapped node list of current node (this list can be empty) at 342 where, after determining if the difference between the end node and start node of an unallocated node exceeds a life-cycle limit, the process retrieves the list of nodes that overlap in memory space with the current unallocated node under consideration. This overlapped node list assists in identifying possible memory spaces—gaps—partitioned by these nodes, thereby enabling the allocation of address space to the unallocated node in subsequent steps.

The process begins with obtaining the list of overlapped nodes for the current node, which may be empty. The subsequent step at 344 involves identifying the memory spaces or gaps that are delineated by these overlapped nodes. These gaps represent potential regions of memory that could be utilized for allocation. The identification of these gaps enables optimizing the memory allocation process, as it ensures that available memory is used efficiently and that nodes are properly assigned to the appropriate memory locations.

Next the process checks whether space is available at 348 as the decision point in the memory allocation process for edge devices managing neural network nodes. This step involves verifying if an appropriately sized memory space is available to accommodate the current unallocated node. If such a space is found, the process allocates the address of this space to the current node. However, if no suitable space exists, alternative steps must be taken to ensure efficient memory management.

At 350, the address of the current node is set to the address of the available memory space. This is part of the memory allocation process where a search is conducted to find the smallest gap that is large enough to accommodate the current node. If space is available, the address of the current node is assigned to this identified space. This ensures that the memory is allocated efficiently, avoiding fragmentation and making optimal use of available memory resources.

Next, the process pushes current node into allocated node list at 354. This operation adds the current node, which has successfully been allocated a memory address, into the list of nodes that have already been allocated. This step ensures that the node is recognized as allocated and is appropriately tracked within the overall memory management process. By doing so, the system maintains an organized record of all allocated nodes, facilitating subsequent memory operations and optimizations.

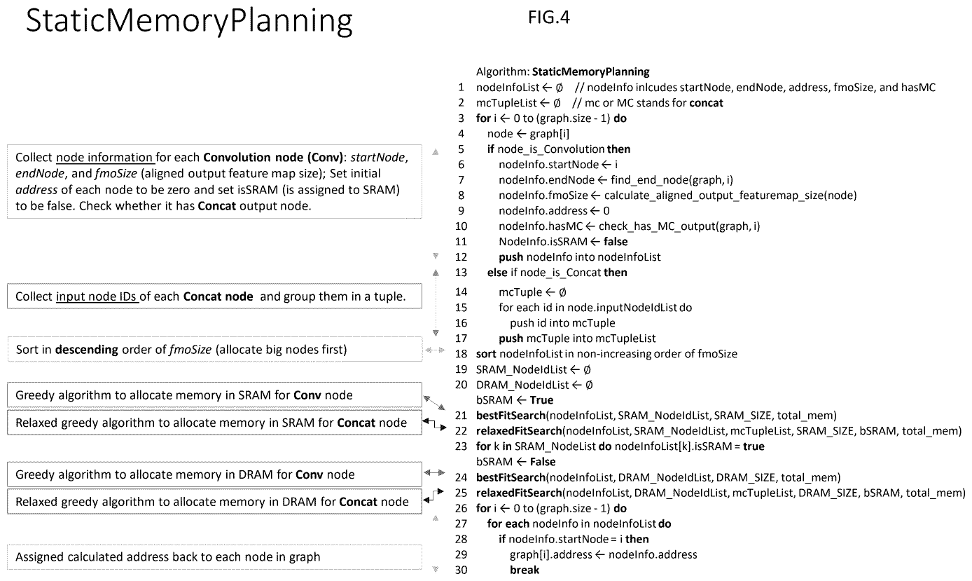

FIG. 4 shows an exemplary pseudo code for performing static memory planning. The code collects convolution node information and initializes the address of the node and the SRAM assignment flag in lines 5-12. The code then groups the input node IDs of each Concat node as a tuple in lines 13-17, and sorts in descending order of output feature map size (fmoSize). A greedy algorithm is applied to allocate SRAM memory for the Conv node, and a relaxed greedy algorithm is used to allocate SRAM memory for Concat node in lines 21-22. Next, for DRAM storage, a greedy algorithm is applied to allocate DRAM memory for the Conv node, and a relaxed greedy algorithm is used to allocate DRAM memory for Concat node in lines 24-25. The calculated address is assigned back to each node in the graph.

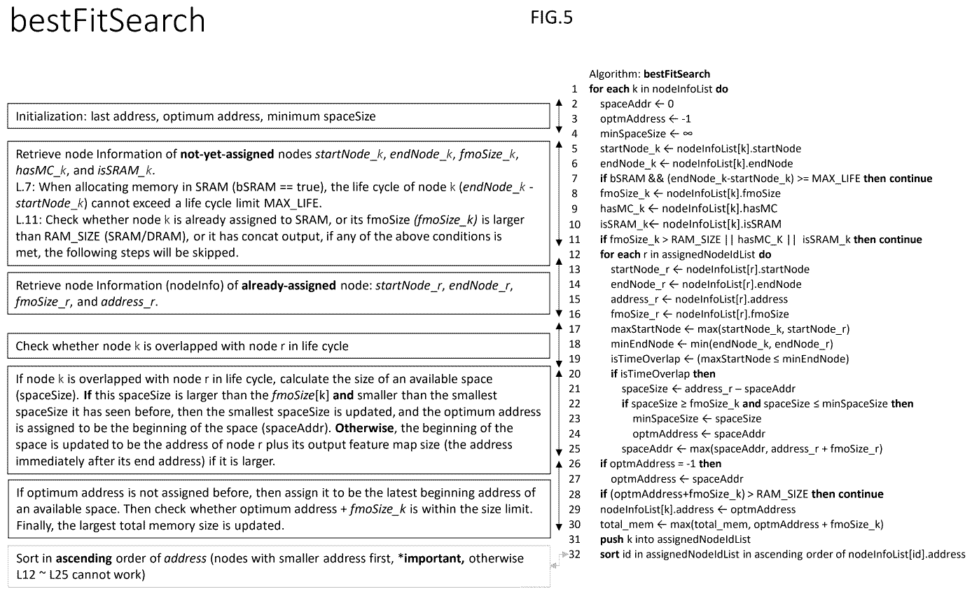

FIG. 5 shows an exemplary pseudo code for performing the best-fit search. Lines 2-4 initialize the last address, optimum address and the minimum space size registers (lines 2-4). The code imposes a life cycle limit MAX_LIFE on the nodes. If the node is already assigned to SRAM, or if the fmo size of the node is larger than the RAM size, or it has concat output, then the following node processing is skipped (lines 5-11). For the remaining node k, lines 17-19 of the code determine if node k is overlapped with node r in life cycle and lines 20-25 calculate the size of an available space (spaceSize) if they do. If this spaceSize is larger than the fmoSize[k] and smaller than the smallest spaceSize previously detected, then the smallest spaceSize is updated, and the optimum address is assigned to be the beginning of the said space (spaceAddr). Otherwise, the beginning of the space is updated to be the address of node r plus its output feature map size (the address immediately after its end address) if it is larger. If optimum address is not assigned before, then assign it to be the latest beginning address of an available space. The code checks whether optimum address plus fmoSize_k (or fmoSize[k]) is within the size limit and then updates largest total memory size (lines 26-30). The assigned nodes are sorted in ascending order of node address (smaller address node is listed first) in line 32.

The procedure sorts the allocated node list in increasing order of assigned address in 356, and then checks if there are still unchecked unallocated nodes at 358. If so, it repeats the allocation process for the remaining unallocated nodes. This ensures that all nodes are efficiently allocated memory addresses, optimizing the storage of intermediate feature maps for deep neural network models.

For scenarios where nodes exceed specified life-cycle limits, the algorithm checks the overlapped node list for memory spaces that can accommodate large life-cycle nodes. The smallest adequate space is identified, and the address of the current node is set to this space's address, after which the node is added to the allocated list and sorted. Unchecked nodes continue through this loop until complete allocation is achieved.

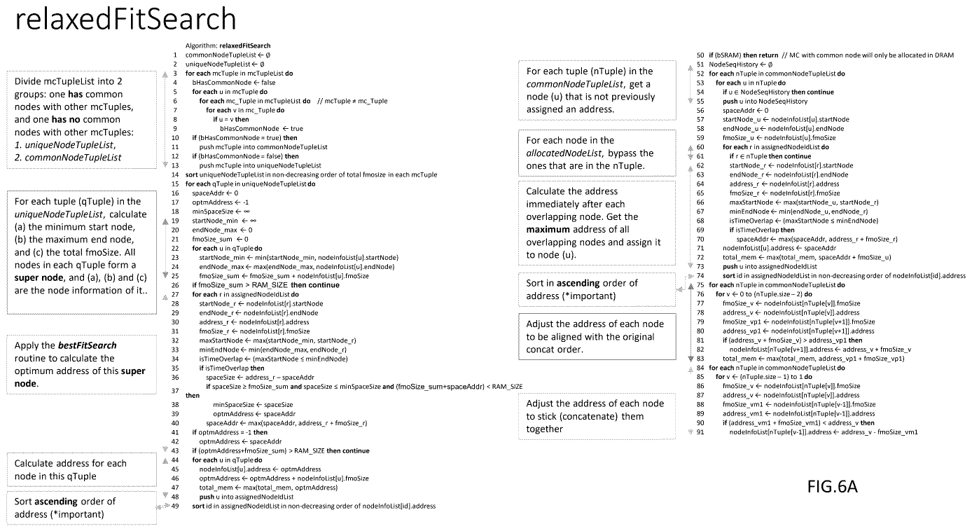

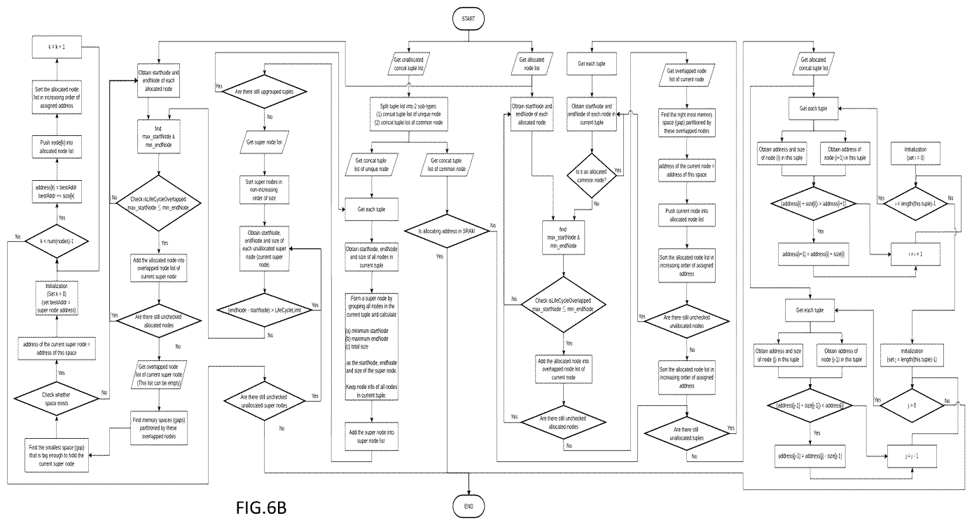

FIG. 6A shows an exemplary pseudo code for performing relaxed-fit search, while FIG. 6B shows the corresponding flowchart. The process divides the common node tuple list into 2 groups: a unique node list and a common node list (lines 3-13). For each tuple (qTuple) in the uniqueNodeTupleList, the code calculates (a) the minimum start node, (b) the maximum end node, and (c) the total fmoSize. All nodes in each qTuple form a super node, and (a), (b) and (c) are the node information (lines 19-25). The code applies bestFitSearch algorithm to calculate the optimum address of the super node (lines 27-43), and calculates the address for the nodes in the qTuple (lines 44-48), and sorts in ascending order of addresses (lines 49). For each tuple (nTuple) in the commonNodeTupleList, the code gets a node (u) that is not previously assigned an address (lines 51-55). For each node in the allocatedNodeList, the code bypasses the ones that are in the nTuple (lines 60-61). For the remaining nodes, the code performs the following: Calculate the address immediately after each overlapping node. Get the maximum address of all overlapping nodes and assign it to node (u) (lines 62-73), sort in ascending address order (line 74); Adjust the address of each node to be aligned with the original concat order (lines 75-83); and Adjust the address of each node to stick (concatenate) them together (lines 84-91). The code of FIG. 6A is illustrated in flowchart form as FIG. 6B.

The remaining address allocations are assigned back to the model graph, mapping each node with its designated memory address. The method ensures optimal memory usage, balancing allocations between SRAM and DRAM to enhance performance, lower power consumption, and meet the stringent memory constraints of edge devices. This one implementation provides a robust framework for managing memory in edge-based NPUs, promoting efficient feature map storage and retrieval in DNN applications.

One implementation also includes the application of specific size limits for memory allocation in both SRAM and DRAM, ensuring that memory usage remains within the constraints of the provided limits. These size limits help to manage memory allocation efficiently, minimizing excess allocation that could reduce the availability of memory for other operations. The proposed method leverages both best-fit and relaxed-fit search algorithms to achieve optimal allocation, considering both immediate and future memory requirements.

By implementing the described methods, one implementation significantly improves the management of memory resources on edge devices, enhancing their capability to run multiple AI models concurrently while keeping memory consumption and power usage to a minimum. This solution is particularly beneficial for devices with stringent memory and power budgets such as edge computing devices and NPUs.

In one example implementation, the method begins with the input of a DNN model graph, which is subjected to node splitting and information extraction to categorize nodes into normal nodes and concat tuples. The concat tuples are lists of nodes that need to be concatenated together, while normal nodes will be sorted in a descending order of feature map size. Following the extraction, the system retrieves both the concat tuple list and the normal node list. Upon assigning an address, the current node is pushed into the allocated node list. The allocated nodes are then sorted by address in ascending order. The system reassesses to determine if any unallocated nodes remain unchecked and repeats as necessary. The next step is selecting the smallest space, or gap, that is both available and sufficient to hold the current node. The algorithm evaluates the size requirements of the current node and compares it against the sizes of the identified gaps. By choosing the smallest sufficient space, the algorithm aims to optimize memory utilization and minimize fragmentation. Finally, the algorithm allocates the starting address of the selected space to the current node. This allocation ensures that the memory address is assigned efficiently, making use of the available memory in a way that accommodates the current node's size and life cycle without wasting resources. Consequently, the current node's address becomes part of the overall allocated node list, ready for integration back into the deep neural network's computational graph. This insertion is done in an orderly fashion, ensuring that the addresses in the allocated node list are sorted in a predetermined order, typically ascending order of addresses, facilitating further operations and memory management tasks.

In a method for efficient memory reuse and allocation for deep neural network (DNN) model graphs on edge devices, the process begins with receiving an input DNN model graph. Nodes within the graph are split and information regarding each node's startNode, endNode, and size are extracted. Two primary lists are created from these nodes: a concat tuple list comprising nodes that need to be concatenated and a normal node list containing the remaining nodes. Nodes within each list are subsequently sorted in descending order of their feature map size. Each allocated node is then inserted back into the allocated node list, which is sorted in ascending order based on the newly assigned memory addresses. For nodes in the concat tuple list that share common nodes with other tuples, memory addresses are allocated exclusively in DRAM. These nodes'memory addresses are assigned immediately after the largest end address of all overlapping nodes previously allocated, recalibrated to prevent overlap with nodes already allocated. This assignment is done in consideration of preserving the logical order of operations in the DNN to avoid discrepancies during graph reconstitution. After allocation, a determination is made regarding whether additional, unchecked allocated nodes exist. If any nodes are left unprocessed, the allocation algorithm iterates until all nodes are appropriately addressed. The goal remains to optimize memory utilization while maintaining computational efficiency and ensuring nodes'life-cycle constraints within SRAM and DRAM limits are observed. Insertion of each addressed node back into the graph ensures a sequential and systematic build-up of allocated memory for running the DNN model. The detailed process entails initially obtaining a list of unallocated nodes and extracting details such as their startNode, endNode, and size. The life cycle overlap between nodes is assessed, marking nodes for SRAM allocation if overlapped with life cycles within acceptable limits. Nodes with life cycles extending the stipulated limit are considered for DRAM allocation. Each node's allocation involves determining spaces within available memory, finding gaps formed by previously allocated and overlapped nodes, selecting the smallest adequate space for fitting the current node, and assigning an address corresponding to this space. Through these methods and steps, the efficient memory reuse method enables optimal allocation of memory addresses in both SRAM and DRAM, thereby reducing memory consumption and power usage for neural processing units (NPUs) on edge devices. This innovative approach leads to significant savings in memory space and improved power efficiency for DNN models deployed on such devices.

The relaxed-fit search algorithm divides concat tuples into two sub-types, concat tuple list of unique node (sub-type 1): the concat tuples that have no shared/common node with other concat tuples, and concat tuple list of common node (sub-type 2): the concat tuples that have shared/common node(s) with other concat tuples. Concat tuple list of unique node can be allocated in either SRAM or DRAM. Concat tuple list of common node can only be allocated in DRAM. This one implementation efficiently reuses memory by addressing the constraints posed by limited memory sizes in edge devices, thereby optimizing the memory allocation process for deep neural network models running on NPUs.

Furthermore, the relaxed-fit search algorithm divides concat tuples into two sub-types: unique nodes with no shared/common nodes with other tuples and common nodes that share common nodes with other tuples. The unique node tuples can be allocated in either SRAM or DRAM, while common node tuples are allocated only in DRAM. For unique node tuples, all nodes in the same tuple are combined into a supernode, with its start node being the minimum start node and its end node the maximum end node of all nodes within the tuple. The total feature map size of all nodes in the tuple defines the size of the supernode. The supernode undergoes the best-fit search algorithm to obtain an address in memory. Once an address is allocated, the address of the first node in the tuple is set as the address of the supernode, and subsequent node addresses are assigned based on the end address of the current node plus its output feature map size. All nodes in the tuple are then inserted into the allocated node list in an ascending order of address.

For each common node tuple, the method assigns addresses immediately after the largest end address of previously allocated overlapping nodes, excluding previously allocated common nodes. In the end, all nodes are inserted into an allocated node list and sorted in ascending order of address. This comprehensive method optimizes the use of memory in edge devices with stringent memory constraints, ensuring efficient and organized storage of the feature maps for neural network models.

In one implementation, a method includes a memory planning algorithm, which divides nodes into two categories: one is normal nodes, which will be sorted in a descending order of its feature map size, and the other is nodes that needs to be concatenated, where a set of nodes that are concatenated together is dubbed as a concat tuple.

The memory planning algorithm utilizes a best-fit search algorithm to allocate memory address for normal nodes, and a relaxed-fit search algorithm to allocate memory address for concat nodes.

The memory planning algorithm allocates memory for intermediate feature maps of each node, in both SRAM and DRAM, and it allocates memory in SRAM first and then it allocates memory in DRAM, and with provided size limit, namely, SRAM size limit and DRAM size limit, and with provided life-cycle limit of nodes to be allocated in SRAM and life-cycle limit of nodes to be allocated in DRAM, whereby SRAM can bypass nodes with excessively long life-cycle.

The best-fit search algorithm aims to efficiently allocate memory addresses for nodes. It begins by obtaining a list of previously allocated nodes that overlap with the current node's life-cycle. Then, it identifies memory spaces partitioned by these allocated and overlapped nodes. The algorithm proceeds to find the smallest space capable of accommodating the current node and assigns the starting address of this space to the current node. Finally, it inserts the current node into the allocated node list and sorts it in ascending order of address.

The relaxed-fit search algorithm, on the other hand, divides concat tuples into two subtypes: unique node tuples and common node tuples. Unique node tuples have no shared nodes with other concat tuples and can be allocated in either SRAM or DRAM. Common node tuples, which share nodes with other concat tuples, are allocated only in DRAM.

For unique node tuples, the algorithm groups all nodes in the same tuple into a supernode. The supernode's start node is the minimum start node of all nodes in the tuple, its end node is the maximum end node, and its size is the total feature map size of all nodes. The supernode then undergoes the best-fit search algorithm to obtain a memory address. The address of the first node in the tuple becomes the supernode's address, and subsequent nodes'addresses are calculated based on the end address of the previous node. All nodes in the tuple are then inserted into the allocated node list and sorted by address.

For common node tuples, the algorithm first assigns addresses to all nodes in the tuple immediately after the largest end address of previously allocated overlapping nodes, excluding previously allocated common nodes. After inserting all nodes into the allocated node list and sorting by address, the algorithm adjusts node addresses to maintain their order in the concat operator. Finally, it concatenates the addresses by moving nodes to the right side in reverse order, ensuring proper alignment and allocation of memory space.

In the process of efficiently allocating memory addresses within a DNN model graph, the addresses of nodes are adjusted according to specific rules to optimize memory usage. If the address of the next node in the sequence is found to be less than the end address of the current node, the system will adjust by assigning the address of the next node to be the end address of the current node. This adjustment helps in maintaining an ascending order of addresses, ensuring that each subsequent node does not overlap with the memory space allocated to the preceding node. Such an adjustment prevents conflicts and ensuring that memory allocation is efficient and organized. As part of a broader memory planning algorithm, this step plays a key role in maintaining the integrity and continuity of memory address ranges assigned to various nodes in the model graph. Specifically, this also involves inserting all nodes into an allocated node list and keeping them sorted in an ascending order of addresses. By doing so, the algorithm not only maximizes the utilization of available memory but also ensures that nodes are sequentially organized in a logical manner. This address adjustment process contributes to an overall reduction in memory fragmentation and allows for more nodes to be accommodated in the limited memory space available, thereby optimizing the performance and efficiency of the neural network processing unit. Consequently, this approach is particularly beneficial for edge devices and NPUs where memory resources are highly constrained and the efficient reuse of memory addresses is paramount.

In yet another implementation, a method is provided for efficient memory space utilization for storing intermediate feature maps for deep neural network models. The method includes a memory planning algorithm, which divides nodes into two categories: one is normal nodes, which will be sorted in a descending order of its feature map size, and the other is nodes that need to be concatenated, where a set of nodes that are concatenated together is dubbed as a concat tuple. The memory planning algorithm utilizes a best-fit search algorithm to allocate memory addresses for normal nodes, and a relaxed-fit search algorithm to allocate memory addresses for concat nodes. The memory planning algorithm allocates memory for intermediate feature maps of each node, in both SRAM and DRAM, and it allocates memory in SRAM first, and then it allocates memory in DRAM, with provided size limits, namely, SRAM size limit and DRAM size limit, and with provided life-cycle limits of nodes to be allocated in SRAM and life-cycle limits of nodes to be allocated in DRAM, whereby SRAM can bypass nodes with excessively long life-cycles. The best-fit search algorithm tries to get a list of nodes that have already been allocated an address and are overlapped in life-cycle with the current node, from an allocated node list; find a list of memory spaces partitioned by The list of allocated and overlapped nodes; find the smallest space that is big enough to hold the current node; allocate the starting address of the space to be the address of the current node; and insert the current node into the allocated node list and sort the allocated node list in ascending order of address. The relaxed-fit search algorithm divides concat tuples into two sub-types, concat tuple list of unique nodes (sub-type 1): the concat tuples that have no shared/common node with other concat tuples, and concat tuple list of common nodes (sub-type 2): the concat tuples that have shared/common node(s) with other concat tuples. Concat tuple list of unique nodes can be allocated in either SRAM or DRAM whereas the concat tuple list of common nodes can only be allocated in DRAM. For each tuple in the concat tuple list of unique nodes, all nodes in the same tuple will be grouped to be a supernode, wherein its start node is the minimum start node of all nodes in the tuple, its end node is the maximum end node of all nodes in the tuple, and its size is the total feature map size of all nodes in the tuple. The supernode will go through the best-fit search algorithm to get an address in the memory; the address of the first node in the tuple is the address of the supernode; the address of the next node ([n+1]) is the end address of the current node ([n]): the address of the current node plus the output feature map size of the current node; insert all nodes in the same tuple into the allocated node list and sort same in ascending order of address. For each tuple in the concat tuple list of common nodes, all nodes in the same tuple will first be assigned the address immediately after the largest end address of all overlapping nodes that have previously been allocated an address; The all overlapping nodes that have previously been allocated an address do not include the previously allocated common node; insert all nodes into the allocated node list and sort the same in ascending order of address; the address of each node will be adjusted so that they preserve the same order in the concat operator: if the address of the next node is less than the end address of the current node, then the address of the next node is assigned to be the end address of the current node. The address of each node will be concatenated together by moving nodes to the right (large) side in a reversed order: if the end address of the previous node ([n−1]) is less than the address of the current node ([n]), the address of the previous node is assigned to be the address of the current node minus the output feature map size of the previous node. This dual-algorithm approach in categorizing nodes and applying specific memory allocation strategies ensures optimized usage of available memory, improved processing efficiency of NPUs, and potentially significant reductions in operational power consumption on edge devices. As edge devices continue to operate with limited memory capacities and high demands for processing capabilities, this method provides a viable solution to enhancing the efficiency and performance of DNN models in resource-constrained environments.

The process begins with the division of neural network nodes. These nodes are categorized into two groups: normal nodes and concat nodes. Normal nodes are those that are processed independently, while concat nodes are groups of nodes that need to be processed together due to operational dependencies such as concatenation of their feature maps. This categorization is crucial as it determines the subsequent steps for memory allocation. After categorizing the nodes, the next step involves sorting the normal nodes. The sorting algorithm arranges these nodes in descending order of their feature map sizes. This is significant because larger nodes need to be considered first during memory allocation to optimally utilize available memory space and minimize fragmentation. For allocating memory addresses to the sorted normal nodes, the device employs a best-fit search algorithm. This algorithm searches for the smallest available memory block that can accommodate the current node. By doing so, it ensures that memory is utilized efficiently, avoiding unnecessary waste of memory space that might occur if larger blocks were allocated when smaller ones suffice.

With the relaxed-fit search algorithm applied on a model with Concat nodes, the memory concatenation for all concat nodes is achieved. Also, the methods described herein reduces power consumption by 46% while reducing DRAM storage by 78%.

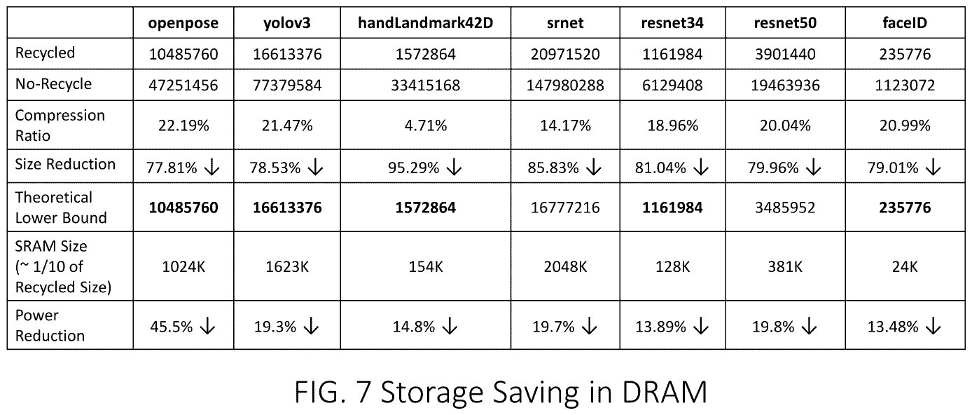

FIG. 7 is a chart illustrating exemplary memory saving examples for various machine learning models such as openpose, yolov3, handLandmark42D, srnet, resnet34, resnet50, and faceID. For each model, the table provides data on recycled and non-recycled storage sizes. The non-recycled storage size refers to the total amount of memory, measured in bytes, required to store the feature maps of each node in a model when no memory reuse techniques are applied. Essentially, it is the sum of the memory used by all feature maps throughout the model's nodes/layers without any optimization for memory efficiency. On the other hand, the recycled storage size is the amount of memory needed to store the feature maps after applying our proposed memory reuse algorithm. This algorithm optimizes the memory usage by reusing memory spaces that are no longer needed by previous layers, thereby reducing the overall memory footprint of the model. The compression ratio is calculated by dividing the recycled storage size by the non-recycled storage size. This ratio reflects the efficiency of memory space compression. Among the models, handLandmark42D has achieved the most efficient compression with a ratio of 4.71%, while resnet 50 has the least compression with a ratio of 20.04%. Size reduction serves as an additional metric for assessing memory reuse efficiency. It is determined by subtracting the compression ratio from 100%, indicating the percentages of storage saved. This metric varies from 77.81% for openpose to 95.29% for handLandmark42D. The theoretical lower bound of each model represents the minimum storage requirements that can be achieved, and no algorithm can surpass this limit. The instant algorithm has achieved this theoretical lower bound for five out of the seven models, with the exceptions being srnet and resnet50.Additionally, SRAM sizes are configured to be approximately one-tenth of the recycled sizes of DRAM, ranging from 24K for faceID to 2048K for srnet. With this configuration, high power reduction is achievable, with openpose achieving the highest reduction at 45.5% while faceID the lowest at 13.48%.

While there has been shown several and alternate embodiments of the present invention, it is to be understood that certain changes can be made as would be known to one skilled in the art without departing from the underlying scope of the invention as is discussed and set forth above and below. Furthermore, the embodiments described above are only intended to illustrate the principles of the present invention and are not intended to limit the scope of the invention to the disclosed elements.

1. A method for storing feature maps for one or more neural network models, comprising:
dividing neural network nodes into normal nodes and concat nodes;
sorting normal nodes in descending order of feature map size;
allocating memory addresses for normal nodes using a best-fit search; and
allocating memory addresses for concat nodes using a relaxed-fit search.

2. The method of claim 1, further comprising allocating memory between static random access memory (SRAM) and dynamic random access memory (DRAM), wherein memory is allocated in SRAM before DRAM.

3. The method of claim 2, further comprising applying size limits for memory allocation in SRAM and DRAM.

4. The method of claim 2, further comprising applying life-cycle limits for nodes to be allocated in SRAM and DRAM.

5. The method of claim 4, comprising bypassing nodes with predetermined life-cycles and allocated to SRAM.

6. The method of claim 1, wherein the best-fit search comprises:
identifying allocated nodes with overlapping life-cycles;
determining memory spaces partitioned by the allocated nodes;
selecting a predetermined memory space to hold a current node; and
allocating a starting address of the predetermined memory space to the current node.

7. The method of claim 6, further comprising inserting a current node into an allocated node list and sorting the allocated node list in ascending address order.

8. The method of claim 1, wherein the relaxed-fit search comprises:
dividing concat nodes into unique node tuples and common node tuples;
allocating unique node tuples in either SRAM or DRAM; and
allocating common node tuples only in DRAM.

9. The method of claim 8, further comprising, for each unique node tuple, grouping nodes into a supernode.

10. The method of claim 9, wherein the supernode comprises:
a start node that is a minimum start node of nodes in the tuple;
an end node that is a maximum end node of nodes in the tuple; and
a size that is a total feature map size of nodes in the tuple.

11. The method of claim 9, further comprising applying the best-fit search to allocate memory for the supernode.

12. The method of claim 11, further comprising:
assigning a supernode address to a start node in the tuple;
assigning subsequent node addresses based on an end address of a previous node; and
inserting nodes in the tuple into an allocated node list and sorting in ascending address order.

13. The method of claim 8, further comprising:
for a common node tuple, assigning addresses immediately after a predetermined end address of previously allocated overlapping nodes, excluding previously allocated common nodes; and
inserting nodes into an allocated node list and sorting the nodes in ascending address order.

14. The method of claim 13, further comprising:
adjusting node addresses within common node tuples to preserve order in a concat operator, wherein if an address of a next node is less than the end address of a current node, assigning a next node address to be the end address of the current node; and
concatenating node addresses by moving nodes in a reversed order and assigning a previous node's address to be a current node's address minus an output feature map size of the previous node if the end address of a previous node is less than the address of the current node.

15. A method for storing neural network models with a memory planning algorithm, comprising:
categorizing neural network nodes into first nodes and second nodes to be concatenated;
sorting first nodes in a descending order of feature map size;
grouping second nodes that are concatenated together into concat tuples;
allocating memory for intermediate feature maps of each node;
using a best-fit search to allocate memory addresses for first nodes; and
using a relaxed-fit search to allocate memory addresses for concat nodes.

16. The method of claim 15, wherein the memory planning comprises allocating memory for intermediate feature maps of each node by:
allocating memory in static random access memory (SRAM) and dynamic random access memory (DRAM);
prioritizing memory allocation in SRAM before allocating memory in DRAM;
adhering to predetermined SRAM and DRAM size limits;
adhering to predetermined life-cycle limits for nodes to be allocated in SRAM and DRAM; and
allowing SRAM to bypass nodes with excessively long life-cycles.

17. The method of claim 15, wherein the best-fit search comprises:
obtaining a list of allocated nodes that overlap in life-cycle with a current node;
identifying memory spaces partitioned by the list of allocated and overlapped nodes;
selecting the smallest space capable of accommodating a current node;
allocating a starting address of the selected space to the current node; and
inserting the current node into an allocated node list and sorting said list in ascending order of address.

18. The method of claim 15, wherein the relaxed-fit search comprises:
dividing concat tuples into:
a concat tuple list of unique nodes having no shared nodes with other concat tuples, allocatable in either SRAM or DRAM; and
a concat tuple list of common nodes having shared nodes with other concat tuples, allocatable only in DRAM;
for tuples in the concat tuple list of unique nodes:
grouping nodes in the tuple into a supernode, wherein a start node is the start node of all nodes in the tuple, an end node is the end node of all nodes in the tuple, and a supernode size is a total feature map size of all nodes in the tuple;
applying a best-fit search to obtain an address for the supernode;
assigning addresses to nodes within the tuple based on the supernode address; and
inserting all nodes in the tuple into an allocated node list and sorting in ascending order of address; and
for each tuple in the concat tuple list of common nodes:
assigning addresses to nodes immediately after the largest end address of previously allocated overlapping nodes, excluding previously allocated common nodes;
inserting all nodes into the allocated node list and sorting in ascending order of address;
adjusting node addresses to preserve the order in the concat operator; and
concatenating node addresses by moving nodes in a reversed order.

19. A system, comprising:
a processor;
one or more neural network models; and
a module to store feature maps for the one or more neural network models, including code for:
dividing neural network nodes into normal nodes and concat nodes;
sorting normal nodes in descending order of feature map size;
allocating memory addresses for normal nodes using a best-fit search; and
allocating memory addresses for concat nodes using a relaxed-fit search.

20. The system of claim 19, comprising static random-access memory (SRAM) and dynamic random-access memory (DRAM) coupled to the processor, wherein memory is allocated in SRAM before DRAM and the processor applies size limits for memory allocation in SRAM and DRAM and applies life-cycle limits for nodes to be allocated in SRAM and DRAM.
